(19) United States
(12) Patent Application Publication
(10) Pub. No.: US 2026/0229591 A1
(43) Pub. Date: Aug. 6, 2026

(54) OXYHALIDE ELECTROLYTES AND EFFICIENT METHODS FOR MAKING THE SAME

(71) Applicant: Florida State University Research Foundation, Inc., Tallahassee, FL (US)

(72) Inventors: Yan-Yan Hu, Tallahassee, FL (US); Thilina Nadeemali Dikella Dikella Gamaralalage, Tallahassee, FL (US); Bright Ogbolu, Tallahassee, FL (US); Ojelade Islamiyat Adenike, Tallahassee, FL (US)

(21) Appl. No.: 19/177,713

(22) Filed: Apr. 14, 2025

Related U.S. Application Data
(60) Provisional application No. 63/633,090, filed on Apr. 12, 2024.

(51) Int. Cl. H01M 10/0562

(52) U.S. Cl. CPC H01M 10/0562; H01M 2300/008

(57) ABSTRACT

In accordance with the purpose(s) of the present disclosure, as embodied and broadly described herein, the disclosure, in one aspect, relates to oxyhalide electrolytes and synthesis of oxyhalide electrolytes. The electrolytes have the general formula A_{z}N_{v-y}L_{y}OX_{5-2y}, exhibit superionic conductivity, and can be produced via a relatively fast synthesis route. The electrolytes can be a component of different types of batteries.

### CROSS-REFERENCE TO RELATED APPLICATIONS

This application claims the benefit of and priority to co-pending U.S. Provisional Patent Application No. 63/633,090, filed on Apr. 12, 2024, the contents of which are incorporated by reference herein in their entireties.

### BACKGROUND

The burgeoning interest towards sustainable and renewable energy has engendered a need to develop fast-ion conducting solid electrolytes to cater for the ever-increasing demand for high-performance electrochemical energy storage devices, such as smart battery systems and all-solid-state batteries. Organic electrolyte-based commercial batteries that currently dominate the global market suffer from several limitations closely linked with safety issues. Therefore, there is a need for solid-state electrolytes with improved mechanical and chemical stability, high energy density, a wide electrochemical window, and economic feasibility for production.

### SUMMARY

In accordance with the purpose(s) of the present disclosure, as embodied and broadly described herein, the disclosure, in one aspect, relates to oxyhalide electrolytes and synthesis of oxyhalide electrolytes. The electrolytes have the general formula A_{z}N_{v-y}L_{y}OX_{5-2y}, exhibit superionic conductivity, and can be produced via a relatively fast synthesis route. The electrolytes can be a component of different types of batteries.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A shows a lab powder X-ray diffraction (PXRD) pattern of Li₂Ta₁₋ₓLaₓOCl₅₋₂ₓ(LTLOC) with different La³⁺ amounts (x=0 to 0.3). An amorphous pattern is observed when x=0, with almost no crystalline peaks. As the La³⁺ content increases, the diffraction peaks proportionately show crystalline peaks like the LaCl₃ crystal structure (P6₃/m). All samples were prepared by ball milling for 2 hours.

FIGS. 1B-1C show ⁶Li NMR (1A) and ⁷Li NMR (1B) for LTOC and LTLOC-0.2 samples showing differences in peak intensity, width, and position, indicative of changes to the lithium local structure with La³⁺ introduction.

FIG. 2A shows a Nyquist plot from electrochemical impedance spectroscopy (EIS) measurements showing ionic conductivities of Li₂Ta₁₋ₓLaₓOCl₅₋₂ₓ prepared via 2-hr mechanochemical synthesis for x=0.2 and 0.3.

FIG. 2B shows variable temperatures impedance plots for Li₂Ta_{0.8}La_{0.2}OCl_{4.6}.

FIG. 2C shows an Arrhenius-like plot for Li₂Ta_{0.8}La_{0.2}OCl_{4.6}, revealing a low activation energy barrier (calculated from the slope), indicative of fast ion motion. The red solid line is only an eye guide.

FIG. 2D shows dependence of ionic conductivity on La³⁺ content in LTLOC. The red and black dashed lines are only eye guides.

FIGS. 2E-2F show results of DC-polarization on a symmetric stainless steel/LTLOC/stainless steel cell for determining electronic conductivity show negligible electron transport (E_{c}) property. The red dashed line is only an eye guide.

FIGS. 3A-3D show the ionic conductivity and activation energy measurements for Li₂Ta_{0.9}Al_{0.1}OCl_{4.8} (a) Nyquist plots from variable temperature EIS measurements (b) Arrhenius plots from variable temperature EIS measurements, in comparison with LAOC and LAC. (c) Equivalent circuit fit at 25° C. (d) A plot comparing the ionic conductivity and activation energy of LTAOC, LAOC and LAC.

FIGS. 4A-4B show the electronic conductivity measurement derived from (a) current vs time curve (b) current vs voltage plot, applying Ohm's law.

FIG. 5 shows the linear sweep voltammetry (LSV) plot for Li₂Ta_{0.9}Al_{0.1}OCl_{4.8}.

FIG. 6 shows the XRD plot of Li₂Ta_{0.9}Al_{0.1}OCl_{4.8} and other lithium compounds.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### DEFINITIONS

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “an excipient” include, but are not limited to, mixtures or combinations of two or more such excipients, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range. Thus, for example, if a component is in an amount of about 1%, 2%, 3%, 4%, or 5%, where any value can be a lower and upper endpoint of a range, then any range is contemplated between 1% and 5% (e.g., 1% to 3%, 2% to 4%, etc.).

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

### Oxyhalide Electrolytes and Methods of Making and Using the Same

The present disclosure provides for oxyhalide electrolytes and the method of making and using oxyhalide electrolytes. The electrolytes have the general formula A_{z}N_{v-y}L_{y}OX_{5-2y} and exhibit superionic properties at low temperatures. The electrolytes can be a component of different types of batteries, such as solid-state batteries. The low-temperature operating range of the electrolytes make them good potential candidates for the use of solid-state batteries in cold climates. The electrolytes can be prepared with a relatively fast synthesis time, which gives the materials good economic viability.

The electrolytes or compounds disclosed herein have the formula A_{z}N_{v-y}L_{y}OX_{5-2y}, where A is Li, Na, K, or any combination thereof; N is Ta, Nb, or any combination thereof; L is La, Al, or any combination thereof; X is Cl, Br, I, or any combination thereof; z is greater than zero to about 2.5; y is greater than zero to about 0.50; v is greater than or equal to y; and the sum (z+5v) is equal to 7. In another aspect, the electrolytes or compounds can also have the formula Li₂Ta_{1-y}La_{y}OCl_{5-2y}. In another aspect, z can be from 0.01 to about 2.5, or about 0.01, 0.1, 0.25, 0.5, 0.75, 1.0, 1.25, 1.5, 1.75, 2.0, 2.25, or 2.5, where any value can be a lower and upper endpoint of a range (e.g., 1.0 to 2.0). In another aspect, v can be from about 0.01 to about 1.50, or about 0.01, 0.10, 0.25, 0.50, 0.75, 1.00, 1.25, or 1.50, where any value can be a lower and upper endpoint of a range (e.g., 0.50 to 1.50). In another aspect, for any formula of electrolyte or compound disclosed herein, y can be from about 0.01 to about 0.50, or 0.01, 0.05, 0.10, 0.15, 0.20, 0.25, 0.30, 0.35, 0.40, 0.45, or 0.50, where any value can be a lower and upper endpoint of a range (e.g., 0.10 to 0.50). In a further aspect, the electrolyte or compound is Li₂Ta_{0.8}La_{0.2}OCl_{4.6}, Li₂Ta_{0.9}Al_{0.1}OCl_{4.8}, or Li₂Ta_{0.9}La_{0.1}OCl_{4.8}.

The electrolytes disclosed herein have several desirable properties. In one aspect, the electrolytes can have good ionic conductivity. The electrolytes can have an ionic conductivity of at least about 1.00 mS/cm, at least about 2.00 mS/cm, at least about 3.00 mS/cm, at least about 4.00 mS/cm, at least about 4.50 mS/cm, at least about 5.00 mS/cm, at least about 5.50 mS/cm, or at least about 6.00 mS/cm. In another aspect, the ionic conductivity of the electrolytes can be from about 1.00 mS/cm to about 10.00 mS/cm, or about 1.00 mS/cm, 2.00 mS/cm, 3.00 mS/cm, 4.00 mS/cm, 5.00 mS/cm, 6.00 mS/cm, 7.00 mS/cm, 8.00 mS/cm, 9.00 mS/cm, or 10.00 mS/cm, where any value can be a lower and upper endpoint of a range (e.g., 5.00 mS/cm to 7.00 mS/cm). In a further aspect, the electrolytes ionic conductivity can be measured at about room temperature, about 18° C. to about 24° C., or about 20° C. to about 22° C. The electrolytes can be characterized as having superionic conductivity, which refers to ionic conductivity values that are greater than 1 mS/cm. In one aspect, the electrolytes remain conductive over a temperature range of about −20 °C. to about 100° C., or about −20° C., −10° C., 0° C., 10° C., 20° C., 30° C., 40° C., 50° C., 60° C., 70° C., 80° C., 90° C., or 100° C., where any value can be a lower and upper endpoint of a range (e.g., −20° C. to 80° C.). In another aspect, the electrolytes exhibit superionic conductivity over the same temperature ranges. Exemplary methods for determining ionic conductivity are provided in the Examples.

In one aspect, the electrolytes disclosed herein can have low electronic conductivities. can have an electronic conductivity of less than about 1.00×10⁻⁸ S/cm, less than about 5.00×10⁻⁹ S/cm, or less than about 2.00×10⁻⁹ S/cm. In another aspect, the electrolytes can have an electronic conductivity of from about 1.00×10⁻⁷ S/cm to about 1.00×10⁻¹⁰ S/cm, or about 1.00×10⁻⁷ S/cm, 5.00×10⁻⁸ S/cm, 1.00×10⁻⁸ S/cm, 5.00×10⁻⁹ S/cm, 1.00×10⁻⁹ S/cm, 5.00×10⁻¹⁰ S/cm, or 1.00×10⁻¹⁰ S/cm, where any value can be a lower and upper endpoint of a range (e.g., 1.00×10⁻⁸ S/cm to 1.00×10⁻¹⁰ S/cm). Exemplary methods for determining electronic conductivity are provided in the Examples.

In another aspect, the electrolytes disclosed herein can have relatively low activation energy barriers to ion transport. The electrolytes can have an activation energy of from about 0.1 eV to about 0.5 eV, or about 0.1 eV, 0.2 eV, 0.3 eV, 0.4 eV, or 0.5 eV, where any value can be a lower and upper endpoint of a range (e.g., 0.2 eV to 0.3 eV).

In one aspect, the structure of the electrolytes can be a hexagonal crystalline phase with the P6₃/m space group. In a further aspect, the electrolytes can include a mixed crystalline phase and glassy phase or amorphous crystalline phase.

The electrolytes described herein have unique X-ray diffraction (XRD) patterns. In one aspect, XRD measurements of the electrolytes are performed using an X-ray wavelength of 0.154 nm and a 2θ range of 10° to 70°. The electrolytes can have an X-ray powder diffraction pattern including peaks at 24.5°, 30.0°, 34.5°, 42.0°, 50.2°, and 60.0°, ±0.2 ° 2θ as measured by X-ray powder diffraction using an x-ray wavelength of 0.154 nm. Exemplary methods for performing powder XRD measurements are provided in the Examples.

Additionally, the electrolytes described herein possess unique solid-state NMR spectra. In one aspect, the Li-containing electrolytes can have peaks at about −1.5 ppm, −0.8 ppm, and −0.2 as determined by ⁶Li solid-state NMR spectroscopy. In another aspect, the Li-containing electrolytes can have peaks at about −1.5 ppm, −0.8 ppm, and 2.4 as determined by ⁷Li solid-state NMR spectroscopy. Exemplary methods for performing NMR measurements are provided in the Examples.

Also disclosed is a method for making sulfide compounds or sulfide electrolytes having the formula A_{z}N_{v-y}L_{y}OX_{5-2y}, where A is Li, Na, K, or any combination thereof; N is Ta, Nb, or any combination thereof; L is La, Al, or any combination thereof; X is Cl, Br, I, or any combination thereof; z is greater than zero to about 2.5; y is greater than zero to about 0.50; v is greater than or equal to y; and the sum (z+5v) is equal to 7. The method includes combining a plurality of precursor compounds, such as salts, in various amounts in the solid state and mixing them together by mechanochemical milling. In one aspect, the precursor compounds are mixed together in stoichiometric amounts. The precursor compounds mixed together can include A₂O, LX₃, NX₅, and any combination thereof, to produce a precursor mixture. In a further aspect, the precursor compounds mixed together can include A₂O, selected from the group of Li₂O, Na₂O, K₂O, and any combination thereof; LX₃, selected from the group of LaCl₃, LaBr₃, LaI₃, AlCl₃, AlBr₃, AlI₃, and any combination thereof ; and NX₅, selected from the group consisting of TaCl₃, TaBr₃, TaI₃, NbCl₃, NbBr₃, NbI₃, and any combination thereof. The components of the precursor mixture can be hand-ground before mechanochemical milling to form a homogenous precursor mixture. In another aspect, forming the precursor mixture and/or forming the homogenous precursor mixture can be performed in an inert atmosphere, such as an argon or nitrogen atmosphere, with an O₂ content of less than 20 ppm, less than 10 ppm, less than 1 ppm, less than 0.5 ppm, or less than 0.1 ppm.

The compounds used to produce the electrolytes described herein are generally highly pure materials. In one aspect, each of the compounds has a purity of greater than 99%, greater than 99.5%, or greater than 99.9%. In one aspect, each compound used to produce the electrolytes are substantially anhydrous, where each compound is at least 95% moisture free, at least 98% moisture free, at least 99% moisture free, at least 99.9% moisture free, or 100% moisture free. In another aspect, each compound has less than 0.5 ppm water, less than 0.25 ppm water, or less than 0.1 ppm water.

The compounds can be mixed by mechanochemical milling. Mixing of the compounds can occur in a mixing jar or container using one or more balls to produce a complex motion that combines back-and-forth swings with short lateral movements. In one aspect, the compounds are mixed with one another for less than seven hours, less than 5 hours, or less than 3 hours. In another aspect, the compounds are mixed from about 1 hour to about 5 hours or about 1 hour, 2 hours, 3 hours, 4 hours, or 5 hours, where any value can be a lower and upper endpoint of a range (e.g., 1 hour to 4 hours.). In one aspect, the compounds are mixed in an inert atmosphere such as, for example, nitrogen or argon. In one aspect, the inert atmosphere has less than 20 ppm oxygen, less than 10 ppm oxygen, less than 1 ppm oxygen, less than 0.5 ppm oxygen, less than 0.25 ppm oxygen, or less than 0.1 ppm oxygen. In some aspects, the mixture is further dried after mixing. After mixing, the mixture can be pelletized. The pellets can be formed by pressing the mechanochemically milled mixture into a mold.

The compounds disclosed herein can be components of different types of batteries, such as solid-state batteries. The component of the battery including the compounds can be an electrolyte, a separator membrane, or a combination thereof. The compounds disclosed herein can also be components of different types of sensors, such as ion-selective electrodes, that are configured for ion detection (e.g., Li⁺ detection). Sensors can be used to measure or detect metal contamination in water sources or biofluids.

### ASPECTS

Aspect 1. A compound having the formula A_{z}N_{v-y}L_{y}OX_{5-2y}, wherein A is Li, Na, K, or any combination thereof; N is Ta, Nb, or any combination thereof; L is La, Al, or any combination thereof; x is Cl, Br, I, or any combination thereof; z is greater than zero to about 2.5; y is greater than zero to about 0.50; v is greater than or equal to y; and the sum (z+5v) is equal to 7.

Aspect 2. The compound of aspect 1, wherein A is Li.

Aspect 3. The compound of aspect 1, wherein A is Na.

Aspect 4. The compound of any one of aspects 1-3, wherein z is from about 1.0 to about 2.0.

Aspect 5. The compound of any one of aspects 1-4, wherein N is Ta.

Aspect 6. The compound of any one of aspects 1-5, wherein v is from about 0.50 to about 1.5.

Aspect 7. The compound of any one of aspects 1-6, wherein L is La.

Aspect 8. The compound of any one of aspects 1-7, wherein y is from about 0.01 to about 0.50.

Aspect 9. The compound of any one of aspects 1-8, wherein X is Cl.

Aspect 10. The compound of any one of aspects 1-8, wherein X is Br.

Aspect 11. The compound of aspect 1, wherein the compound is Li₂Ta_{1-y}La_{y}OCl_{5-2y}.

Aspect 12. The compound of aspect 11, wherein y is from about 0.01 to about 0.50.

Aspect 13. The compound of aspect 11, wherein y is from about 0.01 to about 0.30.

Aspect 14. The compound of aspect 1, wherein the compound is Li₂Ta_{0.8}La_{0.2}OCl_{4.6}.

Aspect 15. The compound of any one of aspects 1-13, wherein the compound has an ionic conductivity of at least 1.00 mS/cm.

Aspect 16. The compound of any one of aspects 1-15, wherein the compound has an ionic conductivity of 1.00 mS/cm to about 10.00 mS/cm.

Aspect 17. The compound of any one of aspects 1-13, wherein the compound has an electronic conductivity of less than about 1.00×10⁻⁸ S/cm.

Aspect 18. The compound of any one of aspects 1-13, wherein the compound has an electronic conductivity of from about 1.00×10⁻⁸ S/cm to about 1.00×10⁻¹⁰ S/cm.

Aspect 19. The compound of any one of aspects 1-18, wherein the compound is conductive over a temperature range of about −20° C. to about 80° C.

Aspect 20. The compound of any one of aspects 1-18, wherein the compound exhibits superionic conductivity over a temperature range of about −20° C. to about 60° C..

Aspect 21. The compound of any one of aspects 1-20, wherein the compound has an activation energy for ion transport of from about 0.1 eV to about 0.5 eV.

Aspect 22. The compound of any one of aspects 1-20, wherein the compound has an activation energy for ion transport of from about 0.2 eV to about 0.3 eV.

Aspect 23. The compound of any one of aspects 1-20, wherein the compound comprises a hexagonal crystalline phase with the space group P6₃/m.

Aspect 24. The compound of any one of aspects 1-23, wherein the compound has an X-ray powder diffraction pattern comprising peaks at 30.0°, 34.5°, and 42.0 °±0.2° 2θ as measured by X-ray powder diffraction using an x-ray wavelength of 0.154 nm.

Aspect 25. The compound of any one of aspects 1-23, wherein the compound has an X-ray powder diffraction pattern comprising peaks at 24.5°, 30.0°, 34.5°, 42.0°, 50.2°, and 60.0°, ±0.2 ° 2θ as measured by X-ray powder diffraction using an x-ray wavelength of 0.154 nm.

Aspect 26. The compound of any one of aspects 1-25, wherein the compound has peaks at about −1.5 ppm, −0.8 ppm, and −0.2 ppm, as determined by 6Li solid-state NMR spectroscopy.

Aspect 27. The compound of any one of aspects 1-25, wherein the compound has peaks at about −1.5 ppm, −0.8 ppm, and 2.4 ppm, as determined by 7Li solid-state NMR spectroscopy.

Aspect 28. A method for making a compound having the formula A_{z}N_{v-y}L_{y}OX_{5-2y}, wherein A is Li, Na, K, or any combination thereof; N is Ta, Nb, or any combination thereof; L is La, Al, or any combination thereof; X is Cl, Br, I, or any combination thereof; z is greater than zero to about 2.5; y is greater than zero to about 0.50; y is less than or equal to v; and the sum (z+5v) is equal to 7. the method comprising (a)combining in the solid state the following components (i) A2O, selected from the group consisting of Li₂O, Na₂O, K₂O, and any combination thereof; (ii) LX₃, selected from the group consisting of LaCl₃, LaBr₃, LaI₃, AlCl₃, AlBr₃, AlI₃, and any combination thereof ; and (iii) NX₅, selected from the group consisting of TaCl₃, TaBr₃, TaI₃, NbCl₃, NbBr₃, NbI₃, and any combination thereof, to produce a precursor mixture; and (b)mixing the precursor mixture by mechanochemical milling.\grave{ }

Aspect 29. The method of aspect 28, wherein precursor mixture is mixed by mechanochemical milling for about 1 hour to about 4 hours.

Aspect 30. The method of aspect 28, wherein precursor mixture is mixed by mechanochemical milling for about 2 hours.

Aspect 31. The method of any one of aspects 28-30, wherein the components are substantially anhydrous.

Aspect 32. The method of any one of aspects 28-31, wherein the components are mixed in an inert atmosphere.

Aspect 33. A compound produced by the method of any one of aspects 28-32.

Aspect 34. A battery comprising the compound in any one of aspects 1-27 and 33.

Aspect 35. The battery of aspect 32, wherein the battery is a solid-state battery.

Aspect 36. A sensor for ion detection, comprising the compound in any one of aspects 1-27 and 33.

Aspect 37. The sensor of aspect 36, wherein the ion to be detected is Li⁺.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### EXAMPLES

The following examples are put forth so as to provide those of ordinary skill in the art with a complete disclosure and description of how the compounds, compositions, articles, devices and/or methods claimed herein are made and evaluated and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure.

### Materials and Methods

### Synthesis

Lithium oxide (99.5% Alfa Aesar), anhydrous LaCl₃ (99.9% Alfa Aesar), and TaCl₅ (99.99% Sigma Aldrich) were all stored in the argon-filled glovebox (VTI), with moisture and O₂ contents of <0.1 ppm each, to avoid moisture and ambient environment. A stoichiometric amount of the precursors was hand-ground for about 5 minutes using an agate mortar and pestle to obtain a homogenous powder. The homogenous mixture was then quantitatively transferred into a 20 mL zirconia milling jar with three 10 mm-sized zirconia balls and vacuum sealed within the argon-filled glovebox. Mechanochemical milling was done using the 8000M Mixer/Mill® High-Energy Ball Mill for 2 hours. The mechanically homogenized sample was stored in a glass vial inside the argon-filled glovebox (MBroun) for further characterization.

### Characterization

Powder X-ray Diffraction—The prepared sample was sealed with Kapton film in a zero-background sample holder. The sample was analyzed in a Rigaku SmartLab X-ray diffractometer with a Cu source. A wavelength of 0.154 nm and a 2θ range of 10° to 70° was used.

Electrochemical Impedance Spectroscopy (EIS)—The sample was hand-ground and pressed in a 10 mm diameter mold to make a ~0.8 mm thick pellet for impedance measurements. The pellet was assembled in a split cell with stainless steel as the blocking electrode. The measurement of potentiostatic EIS was carried out using a Gamry electrochemical analyzer, and conductivities were calculated from the resulting Nyquist plots. Variable temperature EIS characterization was performed from −20° C to 60° C. to calculate the activation energy via Arrhenius plots. Electronic conductivity was measured using the DC polarization method. Equilibrium currents were monitored at different voltages (300, 350, 400, and 450 mV).

Solid-State NMR—^{6;7}Li Magic-Angle-Spinning (MAS) NMR experiments were performed using a Bruker Avance-III 500 spectrometer with an Ultrashield 500 MHz wide-bore magnet with a field of 11.74 T and at a Larmor frequency of 73.6 and 194.3 MHz for ⁶Li and ⁷Li, respectively. The sample powders were packed into 2.5 mm rotors made of ZrO₂ under argon. The MAS rate was 24 kHz. Single pulse NMR experiments were performed with π/2 pulse lengths of 6.53 μs and 6.30 μs and recycle delays of 1000 s and 500 s for ⁶Li and ⁷Li respectively. Inversion recovery ⁷Li T₁ measurements were conducted for LTOLC. Solid LiCl was used as a chemical shift reference at −1.1 ppm.

### Results and Discussion

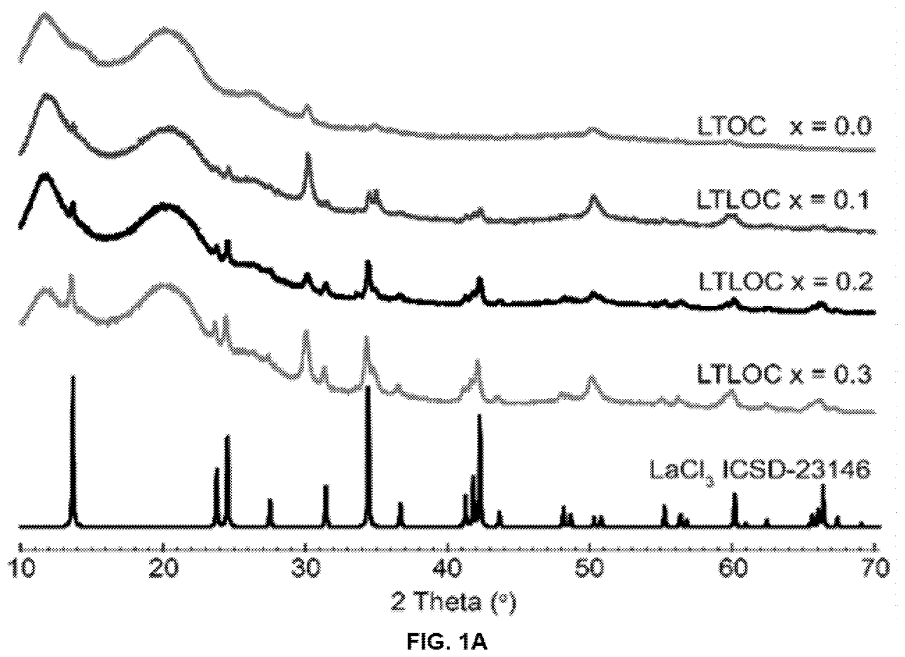

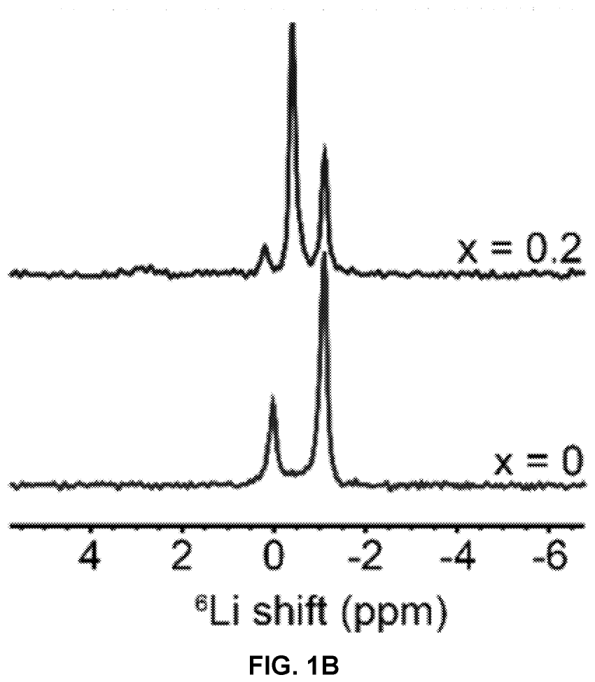

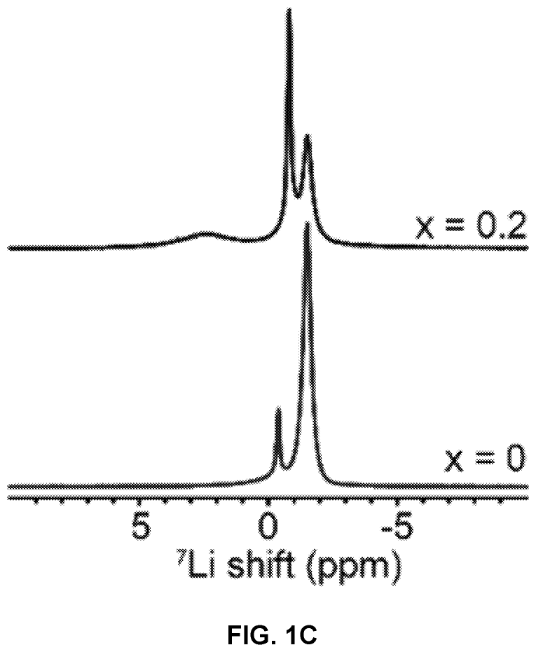

Using a milling time of only 2 hours, Li₂Ta₁₋ₓLaₓOCl₅₋₂ₓ series were prepared by substituting the rarer Ta⁵⁺with the more abundant La³⁺ions. A change in structural property from almost completely disordered to a more ordered configuration is observed with the introduction of Lanthanum, as seen from the emergence of crystalline peaks in the diffraction patterns (FIG. 1A). This is key as it may help with refinement for extracting important structural information in these glassy oxyhalide systems. Notably, the extent to which the crystalline phases appear is proportional to the amount of La³⁺ present in the solid electrolyte, and the peaks tend to assume the hexagonal crystal system of the LaCl₃ lattice. This preliminary analysis points to a glassy-crystalline mixed-phase system. NMR results (FIGS. 1B and 1C) suggest some changes in the local structure upon La introduction. Differences in chemical shifts, peak widths, and intensities of the pristine and doped samples for ^{6/7}Li plots point to a reordering of the Li substructure, that in fact La³⁺ is incorporated into the framework. Further analysis and detailed structural elucidation are currently ongoing.

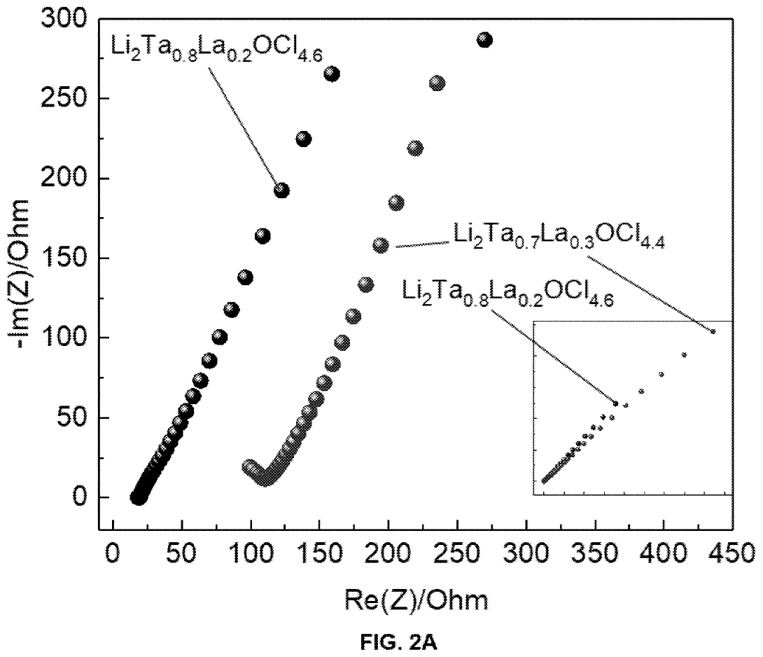

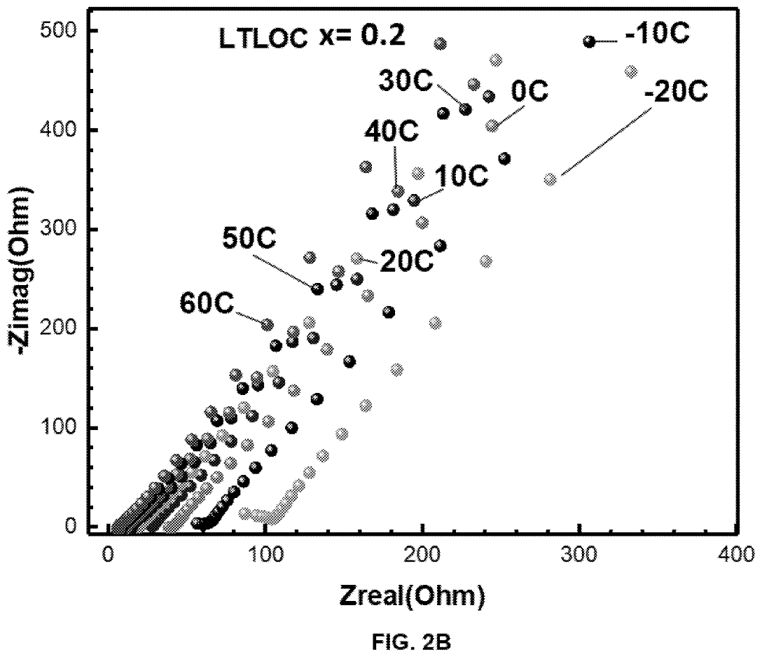

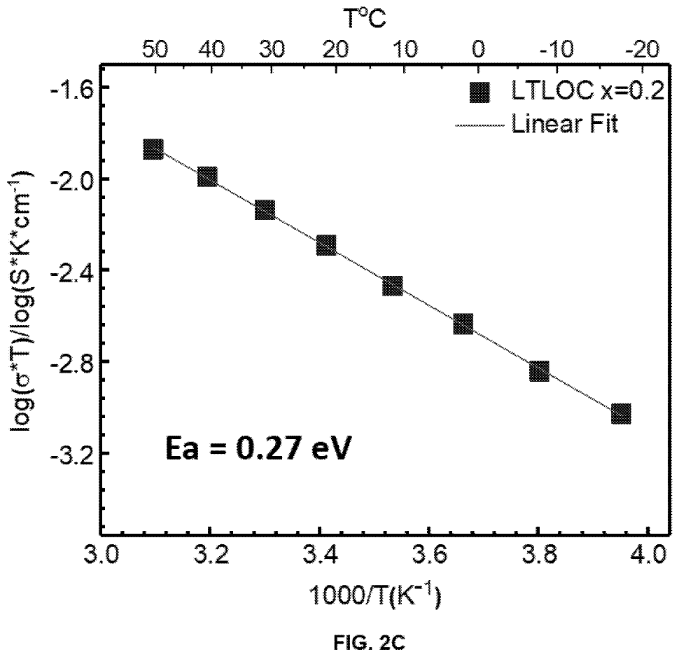

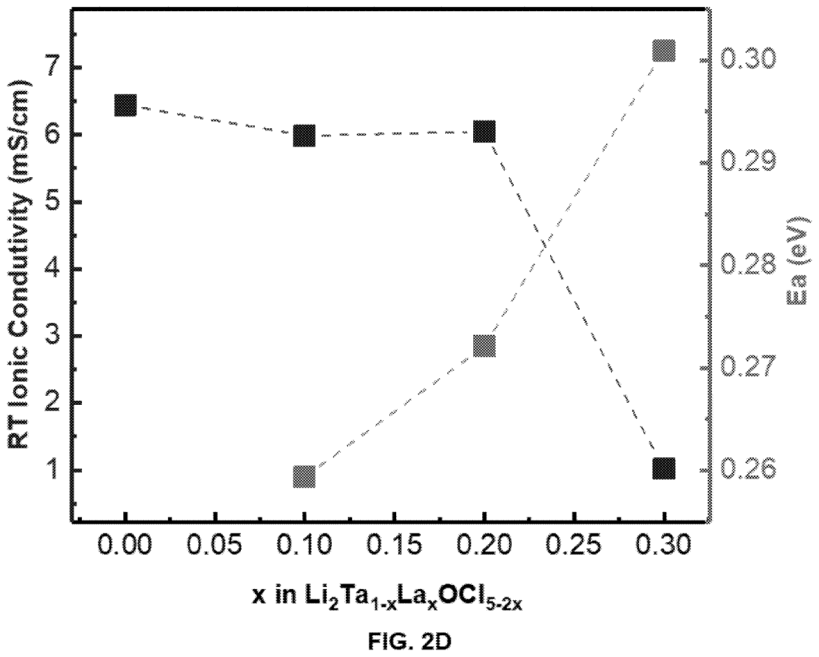

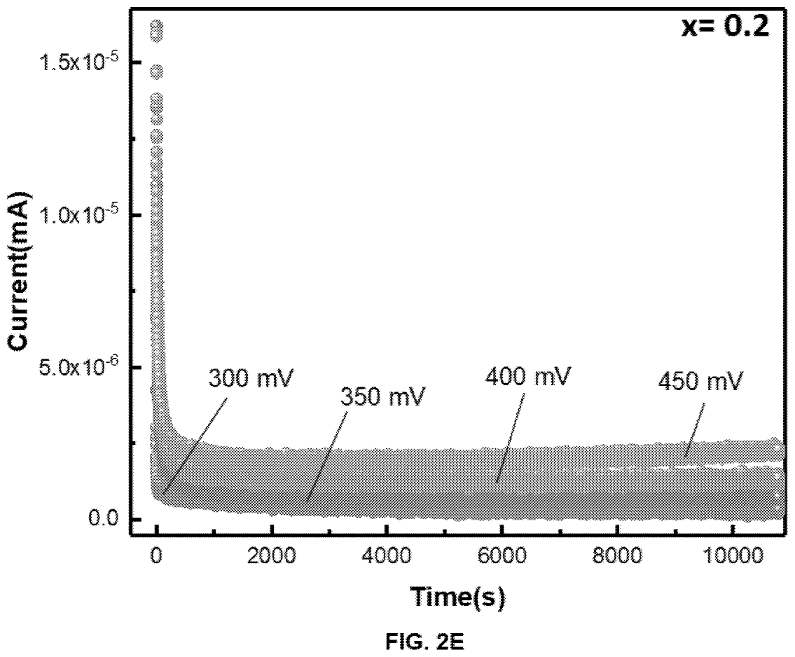

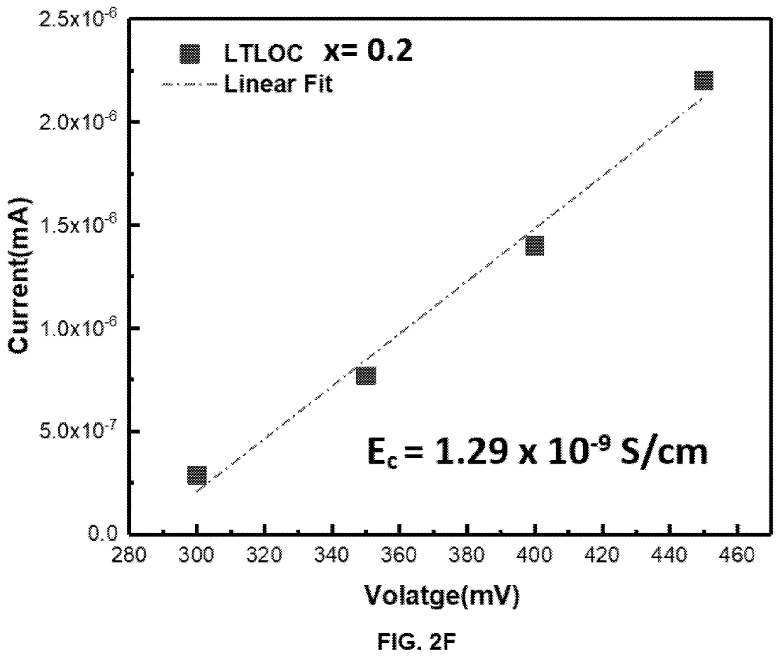

A high RT conductivity of ~6.05 mS/cm was achieved for Li₂Ta_{0.8}La_{0.2}OCl_{4.6} (x=0.2) from electrochemical impedance spectroscopy (EIS) measurements, a composition in which 20% of the Ta⁵⁺ was replaced with La³⁺. A similar conductivity value was obtained for x=0.1. However, upon further introduction of La into the system (x=0.3), a decline in ionic to ~1 mS/cm was observed (FIG. 2A). A reason for this could be the increase in the activation energy barrier for Li-ion hops with increased La amounts.

Variable temperature EIS analysis was conducted for the electrolytes using the temperature ranges 60° C. to −20° C. (FIG. 2B). From the plots, it can be observed that the LTLOC solid electrolyte (x=0.2 in this case) remained stable within this temperature window and even exhibits superionic properties at temperatures as low as −20° C.. This low-temperature operational range of the electrolyte is important for potential use of solid-state batteries in cold climates.

A plot of the log scale conductivities obtained at the different temperatures against inverse Kelvin temperature (FIG. 2C) was fitted with a linear function and the activation energy was estimated from the slope using an Arrhenius-like type equation. An activation energy barrier of 0.26, 0.27 and 0.30 was determined for x values of 0.1, 0.2, and 0.3 respectively. These low activation energy values partly explain the overall superionic property observed for the solid electrolytes, as the energy penalty required for Li jumps from one site to the other is appreciably minimal. As expected, a strong correlation exists between an increase in ionic conductivity values and a decrease in the activation energy barrier in the LTLOC series (FIG. 2D). The relatively lower ionic conductivity value obtained for LTLOC-0.3 can be ascribed to its higher activation energy barrier property.

The electronic conductivity for the LTLOC solid electrolyte was obtained from the plot of current vs. time (FIG. 2E) using direct current polarization method. Equilibrium currents were monitored at different voltages to increase the accuracy of DC polarization measurements. Then, using Ohm's law (V=IR), the electronic conductivities can be determined from the voltage vs. current plot ⁸ (FIG. 2F). The electrolyte displays a low electronic conductivity of 1.29×10⁻⁹ S/cm, indicating a negligible electron transport contribution to the measured total conductivity. LTLOC is a true ion conductor.

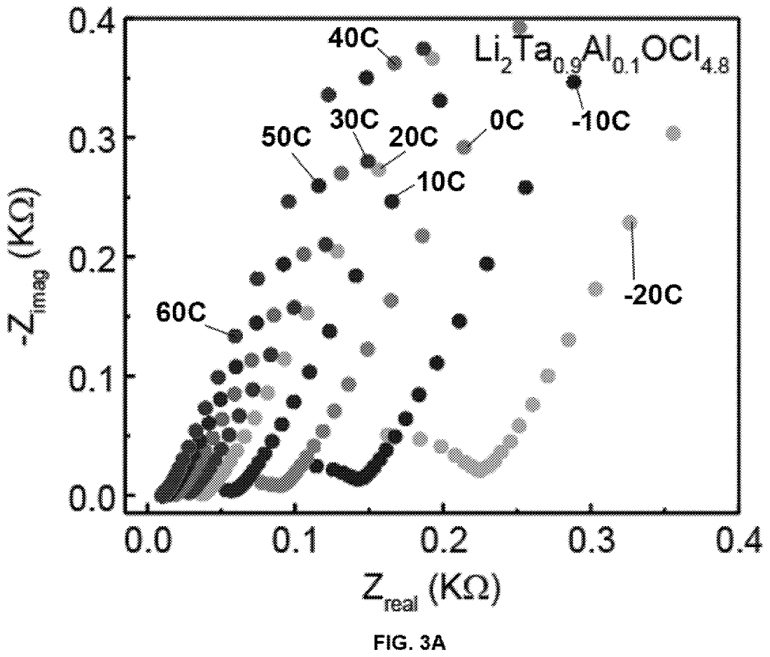

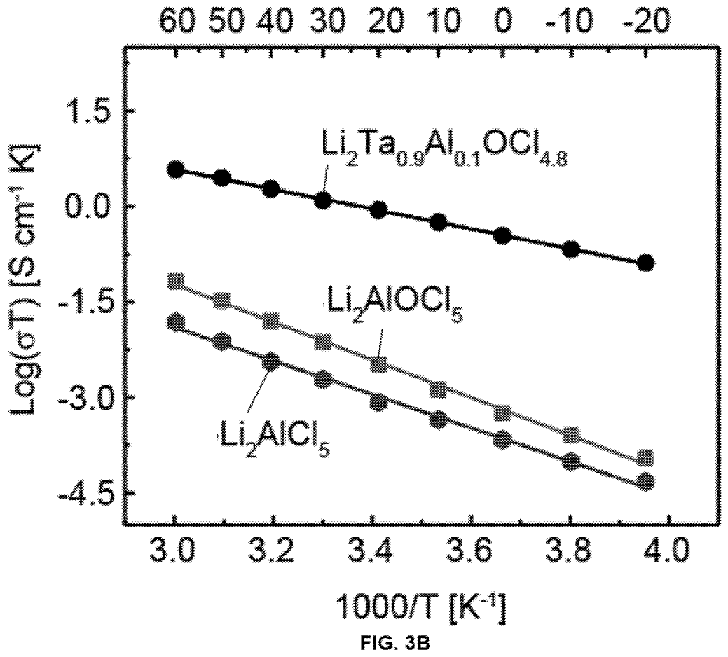

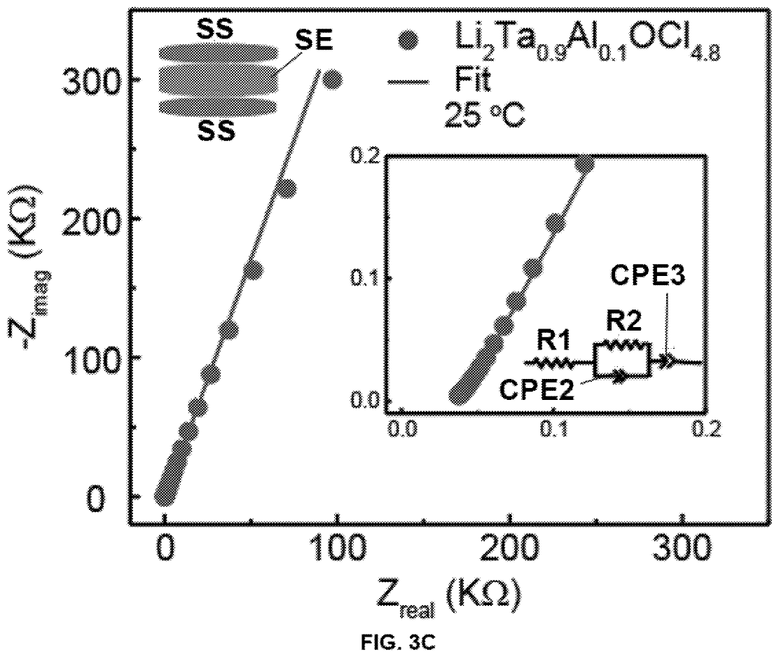

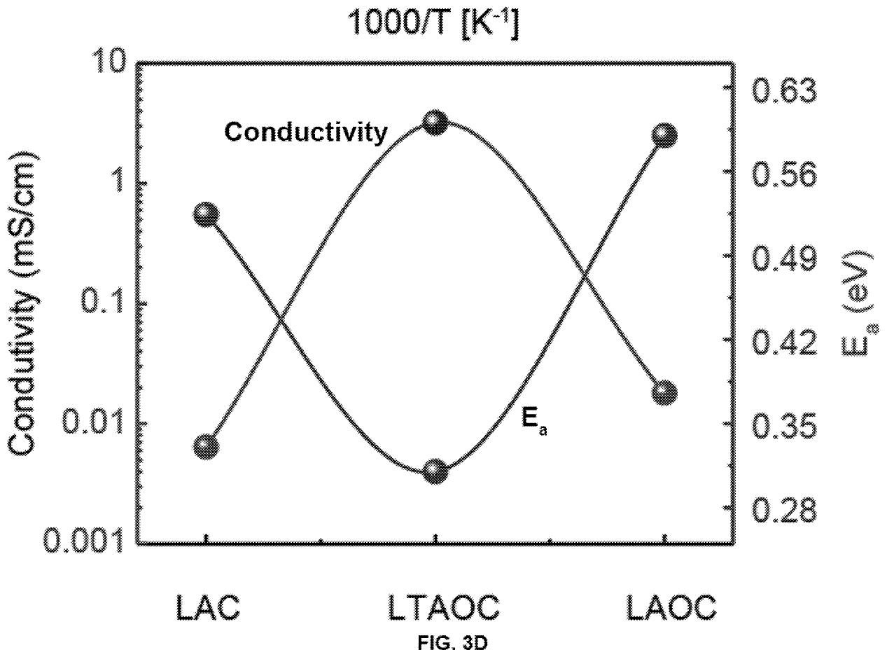

An additional compound described herein (Li₂Ta_{0.9}Al_{0.1}OCl_{4.8}) was further evaluated. FIGS. 3A-3D show the ionic conductivity and activation energy measurements for Li₂Ta_{0.9}Al_{0.1}OCl_{4.8} (FIG. 3A) Nyquist plots from variable temperature EIS measurements and (FIG. 3B) Arrhenius plots from variable temperature EIS measurements, in comparison with LAOC and LAC. FIG. 3C shows the equivalent circuit fit at 25° C.. FIG. 3D shows a plot comparing the ionic conductivity and activation energy of LTAOC, LAOC and LAC.

For the Al analog of Li₂Ta_{0.8}La_{0.2}OCl_{4.6}, we achieved a superionic conductivity of ca. 3.2 mS/cm with an activation energy of 0.3 eV. Compared with other aluminum based solid electrolytes, LAOC and LAC exhibited a conductivity of 0.02 mS/cm and 0.006 mS/cm respectively, with activation energies above 0.5 eV each.

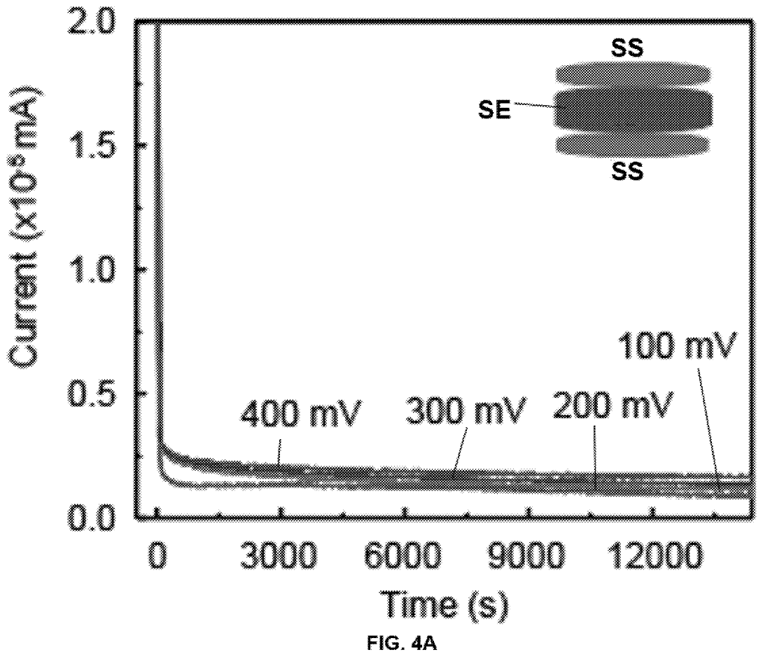

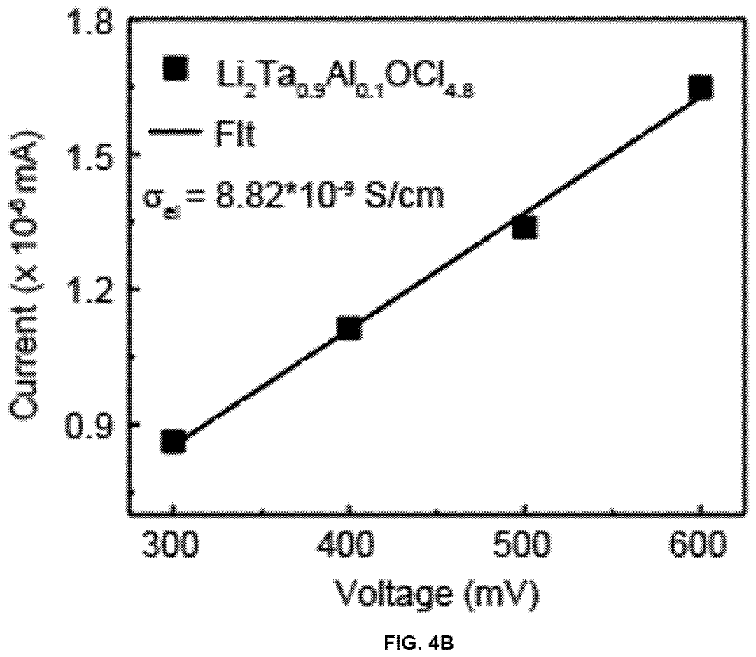

FIGS. 4A-4B show the electronic conductivity measurement derived from (a) current vs time curve (b) current vs voltage plot, applying Ohm's law for Li₂Ta_{0.9}Al_{0.1}OCl_{4.8}. The electronic conductivity was determined to be 8.8×10⁻⁹ S/cm, indicating that the measured total conductivity in LTAOC is purely ionic, with negligible electronic contributions.

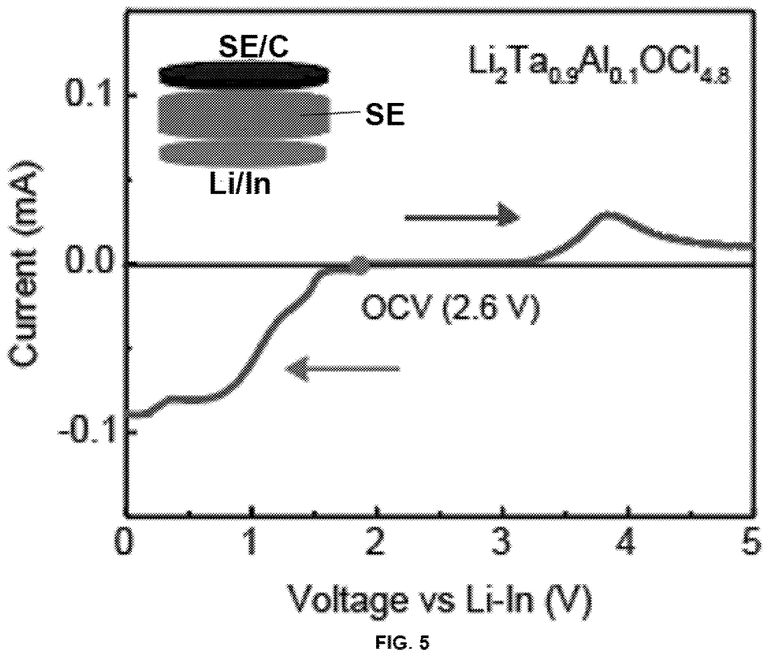

FIG. 5 shows the linear sweep voltammetry (LSV) plot for Li₂Ta_{0.9}Al_{0.1}OCl_{4.8}. This demonstrates a relatively large and stable electrochemical window, ranging from ~1.6 V to ~3.2 V. This implies that the solid electrolyte can be used with certain high-voltage (>3 V vs. Li-In) cathodes.

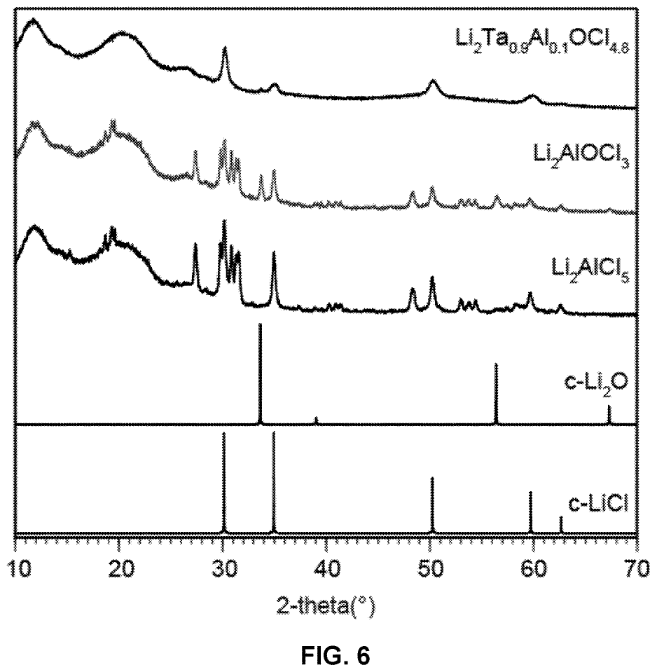

FIG. 6 shows the XRD plot of Li₂Ta_{0.9}Al_{0.1}OCl_{4.8} and other lithium compounds. The absence of well-defined Bragg peaks in LTAOC indicates it's a highly amorphous or short-range ordered material.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### REFERENCES

(1) Janek, J.; Zeier, W. G. A Solid Future for Battery Development. Nature Energy. Nature Publishing Group Sep. 8, 2016. DOI:10.1038/nenergy.2016.141.
(2) Sun, Y. K. Promising All-Solid-State Batteries for Future Electric Vehicles. ACS Energy Letters. American Chemical Society Oct. 9, 2020, pp 3221-3223. DOI:10.1021/acsenergylett.0c01977.
(3) Janek, J.; Zeier, W. G. Challenges in Speeding up Solid-State Battery Development. Nature Energy. Nature Research 2023. DOI:10.1038/s41560-023-01208-9.
(4) Wang, Y.; Richards, W. D.; Ong, S. P.; Miara, L. J.; Kim, J. C.; Mo, Y.; Ceder, G. Design Principles for Solid-State Lithium Superionic Conductors. Nat Mater 2015, 14 (10), 1026-1031. DOI:10.1038/nmat4369.
(5) Tanaka, Y.; Ueno, K.; Mizuno, K.; Takeuchi, K.; Asano, T.; Sakai, A. New Oxyhalide Solid Electrolytes with High Lithium Ionic Conductivity &gt;10 MS/Cm for All-Solid-State Batteries. Angewandte Chemie International Edition 2023. DOI:10.1002/anie.202217581.
(6) Hu, L.; Wang, J.; Wang, K.; Gu, Z.; Xi, Z.; Li, H.; Chen, F.; Wang, Y.; Li, Z.; Ma, C. A Cost-Effective, Ionically Conductive and Compressible Oxychloride Solid-State Electrolyte for Stable All-Solid-State Lithium-Based Batteries. Nat Commun 2023, 14 (1). DOI:10.1038/s41467-023-39522-1.
(7) Zhang, S.; Zhao, F.; Chen, J.; Fu, J.; Luo, J.; Alahakoon, S. H.; Chang, L. Y.; Feng, R.; Shakouri, M.; Liang, J.; Zhao, Y.; Li, X.; He, L.; Huang, Y.; Sham, T. K.; Sun, X. A Family of Oxychloride Amorphous Solid Electrolytes for Long-Cycling All-Solid-State Lithium Batteries. Nat Commun 2023, 14 (1). DOI:10.1038/s41467-023-39197-8.
(8) Zhou, L.; Zuo, T.; Li, C.; Zhang, Q.; Janek, J.; Nazar, L. F. Li3-XZrx(Ho/Lu)1-XCl6 Solid Electrolytes Enable Ultrahigh-Loading Solid-State Batteries with a Prelithiated Si Anode. ACS Energy Lett 2023, 8 (7), 3102-3111. DOI:10.1021/acsenergylett.3c00763.

1. A compound having the formula A_{z}N_{v-y}L_{y}OX_{5-2y}, wherein
A is Li, Na, K, or any combination thereof;
N is Ta, Nb, or any combination thereof;
L is La, Al, or any combination thereof;
x is Cl, Br, I, or any combination thereof;
z is greater than zero to about 2.5;
y is greater than zero to about 0.50;
v is greater than or equal to y; and
the sum (z+5v) is equal to 7.

2. The compound of claim 1, wherein A is Li or Na.

3. The compound of claim 1, wherein z is from about 1.0 to about 2.5.

4. The compound of claim 1, wherein N is Ta.

5. The compound of claim 1, wherein v is from about 0.50 to about 1.50.

6. The compound of claim 1, wherein L is La.

7. The compound of claim 1, wherein y is from about 0.01 to about 0.50.

8. The compound of claim 1, wherein X is Cl or Br.

9. The compound of claim 1, wherein the compound is Li₂Ta_{1-y}La_{y}OCl_{5-2y}.

10. The compound of claim 1, wherein the compound is Li₂Ta_{0.8}La_{0.2}OCl_{4.6}.

11. The compound of claim 1, wherein the compound has an ionic conductivity of 1.00 mS/cm to about 10.00 mS/cm.

12. The compound of claim 1, wherein the compound has an electronic conductivity of from about 1.00×10⁻⁸ S/cm to about 1.00×10⁻¹⁰ S/cm.

13. The compound of claim 1, wherein the compound is conductive over a temperature range of about −20° C. to about 80° C..

14. The compound of claim 1, wherein the compound exhibits superionic conductivity over a temperature range of about −20° C. to about 60° C..

15. The compound of claim 1, wherein the compound has an activation energy for ion transport of from about 0.1 eV to about 0.5 eV.

16. A method for making a compound having the formula A_{z}N_{v-y}L_{y}OX_{5-2y}, wherein
A is Li, Na, K, or any combination thereof;
N is Ta, Nb, or any combination thereof;
L is La, Al, or any combination thereof;
x is Cl, Br, I, or any combination thereof;
z is greater than zero to about 2.5;
y is greater than zero to about 0.50;
y is less than or equal to v; and
the sum (z+5v) is equal to 7.
the method comprising:
(a) combining in the solid state the following components: (i) A₂O, selected from the group consisting of Li₂O, Na₂O, K₂O, and any combination thereof; (ii) LX₃, selected from the group consisting of LaCl₃, LaBr₃, LaI₃, AlCl₃, AlBr₃, AlI₃, and any combination thereof ; and (iii) NX₅, selected from the group consisting of TaCl₃, TaBr₃, TaI₃, NbCl₃, NbBr₃, NbI₃, and any combination thereof, to produce a precursor mixture; and
(b) mixing the precursor mixture by mechanochemical milling. \grave{ }

17. The method of claim 16, wherein precursor mixture is mixed by mechanochemical milling.

18. A compound produced by the method of claim 16.

19. A battery comprising the compound of claim 1.

20. A sensor for ion detection comprising the compound of claim 1.
